(19) United States
(12) Patent Application Publication
(10) Pub. No.: US 2025/0189002 A1
(43) Pub. Date: Jun. 12, 2025

(54) SEAL ASSEMBLY FOR A BRAKE PISTON ASSEMBLY

(71) Applicants: ZF Automotive Technologies (Shanghai) Co., Ltd., Shanghai (CN); ZF Active Safety GmbH, Koblenz (DE)

(72) Inventors: Florian Roessinger, Neuwied (DE); Yi Cao, Shanghai (CN); Lian Wang, Dongyang (CN); Lukas Madzgalla, Lahnstein (DE); Markus Mallmann, Pfalzfeld (DE)

(73) Assignees: ZF Automotive Technologies (Shanghai) Co., Ltd., Shanghai (CN); ZF Active Safety GmbH, Koblenz (DE)

(21) Appl. No.: 18/975,985

(22) Filed: Dec. 10, 2024

(30) Foreign Application Priority Data
Dec. 11, 2023 (CN) 202311696134.7

(51) Int. Cl. F16D 65/18; F16D 125/06; F16D 125/08

(52) U.S. Cl. CPC F16D 65/18; F16D 2125/06; F16D 2125/08

(57) ABSTRACT

A seal assembly for a brake piston assembly has an encircling fixing portion, and a seal portion which can be extended and/or compressed axially. The seal portion has a fastening element, spaced apart axially from the fixing portion by a first distance and is arranged closer to the axial end of a brake piston than the fixing portion, and a first connection portion, which is spaced apart axially from the fastening element by a second distance, which is smaller than the first distance, or is not spaced apart axially from the fastening element, and by which the seal portion is connected to the fixing portion. The seal assembly has sealing lip connected to the fixing portion by a second connection portion spaced apart axially from the fastening element by a third distance, which is greater than the second distance. The sealing lip 40 extends from the second connection portion as far as a contact portion, which is spaced apart axially from the fastening element by a fourth distance, which is smaller than the third distance. The sealing lip has a profile which slopes relative to the axis of symmetry.

### CROSS-REFERENCE TO RELATED APPLICATIONS

This application claims priority to Chinese Patent Application No. 202311696134.7, filed Dec. 11, 2023, the disclosure of which is incorporated herein by reference in its entirety.

### TECHNICAL FIELD

The present disclosure relates to a seal assembly for a brake piston assembly for an electromechanical motor vehicle disc brake. The disclosure furthermore relates to a brake piston assembly having a seal assembly of this kind and to an electromechanical motor vehicle disc brake having the abovementioned components.

### BACKGROUND

A seal assembly is used in an associated brake piston assembly to protect a brake piston accommodated in an axially movable manner in a brake piston receptacle of a brake caliper housing, and also to protect the brake piston receptacle from penetrating contamination. Electromechanical motor vehicle disc brakes generally comprise brake piston assemblies of this kind and rotation-translation mechanisms in the region of the brake piston and of the brake piston receptacle or within the brake piston. Such rotation-translation mechanisms are widely embodied as spindle drives. The relevant seal assemblies thus also serve to protect the rotation-translation mechanism or rotation-translation mechanisms, in the case where the disc brake or the brake piston assembly comprises a plurality of rotation-translation mechanisms, from dirt and dust. Furthermore, seal assemblies of this kind perform a guiding function for guidance of the brake piston, and, in the case where lubricant is used to lubricate the brake piston guide and the rotation-translation mechanisms, the seal assemblies also serve to prevent or limit the escape of the corresponding lubricant.

Seal assemblies of this kind are known from the prior art. For example, DE 10 2022 119 398 A1 discloses a corresponding assembly.

What is needed is to provide a seal assembly for a brake piston assembly of an electromechanical motor vehicle disc brake which results in simplified assembly and more reliable positioning in the brake piston assembly, and which reliably prevents the penetration of dirt and dust and guides the brake piston in an optimum manner.

### SUMMARY

According to an exemplary arrangement of the disclosure, a seal assembly is proposed. In addition, a brake piston assembly having a seal assembly is also disclosed herein. An electromechanical motor vehicle disc brake utilizing a seal assembly is also disclosed herein. Advantageous exemplary arrangements of the disclosure are set forth in the dependent claims.

Where reference is made in the context of a seal assembly to a brake piston assembly and the components thereof or to an electromechanical motor vehicle disc brake and the components thereof, e.g. a brake pad assembly, this is intended to clearly define the different elements of the seal assembly and to illustrate the advantages of the elements of the seal assembly relative to the prior art. Moreover, where reference is made in the context of the brake piston assembly to an electromechanical motor vehicle disc brake, this is likewise intended to clearly define the different elements of the brake piston assembly and to illustrate the advantages of the invention relative to the prior art.

The seal assembly according to an exemplary arrangement is intended for a brake piston assembly for an electromechanical motor vehicle disc brake. The brake piston assembly comprises a brake caliper housing and a brake piston, which can be moved axially in a brake piston receptacle of the brake caliper housing and has an axial end which projects from the brake caliper housing and can apply an actuating force in an axial direction to a brake pad assembly which is present and associated therewith in the mounted state of the brake piston assembly in an electromechanical motor vehicle disc brake. The seal assembly has an encircling fixing portion for fixing the seal assembly in the brake caliper housing, and the seal assembly is of rotationally symmetrical configuration with respect to an axis of symmetry. To allow axial movement of the brake piston relative to the brake caliper housing, the seal assembly furthermore has a seal portion. This seal portion can be extended or compressed axially or can be both extended and compressed axially. The seal portion comprises a fastening element, which is spaced apart axially from the fixing portion by a first distance a1 and is arranged closer to the axial end of the brake piston than the fixing portion. The fastening element can be fastened in an encircling and sealing manner on the brake piston. In one exemplary arrangement, the seal portion is fastened on the brake piston in an encircling and sealing manner by an annular groove encompassed by the brake piston. The fastening element is accommodated in the annular groove. The seal portion furthermore has a first connection portion, which is spaced apart axially from the fastening by a second distance a2, which is smaller than the first distance a1, or which is not spaced apart axially from the fastening element, and by which the seal portion is connected in an encircling manner to the fixing portion. The seal assembly furthermore has an encircling sealing lip, which is connected in an encircling manner to the fixing portion by a second connection portion. The second connection portion is spaced apart axially from the fastening by a third distance a3, which is greater than the second distance a2, and is arranged further away from the axial end of the brake piston than the fastening element. The sealing lip extends from the second connection portion as far as a contact portion, which is spaced apart axially from the fastening element by a fourth distance a4, which is smaller than the third distance a3. At least in an unmounted state of the seal assembly, the sealing lip has a profile which slopes relative to the axis of symmetry, such that the contact portion is at a first radial distance r1 from the axis of symmetry, and the second connection portion is at a second radial distance r2 from the axis of symmetry, which is greater than the first radial distance r1. Thus, in a sectional view, the sealing lip forms an elongate profile, the contact portion of which is aligned in an inclined manner towards the axis of symmetry and, in the installed state, towards the brake piston circumferential surface. A seal assembly of this kind allows simplified mounting and more reliable positioning. Moreover, it reliably prevents the penetration of dirt and dust and provides optimized guidance of the brake piston.

The expression “axial” or “in the axial direction” refers to the alignment of the longitudinal axis of a brake piston in the installed state of the seal assembly into a corresponding brake piston assembly or onto the longitudinal axis of the brake piston receptacle. That is to say that “in the axial direction” or “axial” means running parallel to the said longitudinal axes or along the longitudinal axes. The axis of symmetry coincides with the said longitudinal axes or is offset parallel to the said longitudinal axes.

The said portions or elements to which the axial distance indicators a1, a2, a3 and a4 relate can each have an extent in the axial direction. In this case, the respective distance reference point relates to the centre of the respective extent.

In one exemplary arrangement, in a mounted state of the seal assembly in the brake piston assembly, the contact portion rests against the piston circumferential surface of the brake piston and exerts a first contact force F1 against it, wherein the second connection portion does not rest against the piston circumferential surface or exerts a lower contact force F2 on the piston circumferential surface than the first contact force F1.

In one exemplary arrangement, the sealing lip is manufactured from an elastically deformable elastomer, and the first contact force is brought about exclusively on the basis of the deformation of the sealing lip produced in an installed state of the seal assembly in the brake piston assembly. This contributes to a simplified mounting since, during mounting, only the elastic forces which result from the elasticity of the material have to be overcome at the brake piston. This is particularly significant in avoiding damage during mounting, for example in the case of brake piston assemblies, which represent safety-relevant assemblies.

In one exemplary arrangement, the seal assembly may be composed predominantly of an elastically deformable elastomer. The advantages described in the preceding paragraph are also obtained in the context of this type of material.

In one exemplary arrangement, the fixing portion has an encircling metal reinforcement. The encircling metal reinforcement may be internal. This means that the metal reinforcement is surrounded by the material of the seal assembly. In the case of a seal assembly which is composed of an elastically deformable elastomer or comprises such a material, the internal metal reinforcement can be surrounded by the deformable elastomer.

In one exemplary arrangement, the encircling metal reinforcement comprises an encircling metal insert which is angular or S-shaped when considered in profile. A profile view of this kind is obtained in a section plane which coincides with the axis of symmetry or, in other words, in a half section of the seal assembly. The angular or S-shaped encircling metal insert contributes to simplified mounting since, as a result, the seal assembly has increased rigidity in the region of the fixing portion. The fixing portion can thereby be driven more effectively into the bore portion and, as a result, can also be held accurately in position and reliably in the bore portion or brake piston assembly.

The seal portion may comprise a bellows, which has folds with elongate portions and curved portions connecting in each case two adjacently arranged elongate portions. The elongate portions are aligned substantially parallel to the axis of symmetry. Alternatively, the longitudinal portions can also be aligned substantially transversely to the axis of symmetry.

In one exemplary arrangement, the fixing portion, the seal portion and the sealing lip are connected integrally to one another. Alternatively or in addition, the fastening, the first connection portion and the fixing portion are connected integrally to one another. Alternatively or in addition to the above mentioned connections, the contact portion, the second connecting portion and the fixing portion are connected integrally to one another. In the case where all the elements mentioned above in this paragraph of the text are connected integrally to one another, there is the advantage of simplified mounting since in this case the seal assembly can be mounted in one working step.

The brake piston assembly according to the disclosure for an electromechanical motor vehicle disc brake comprises a seal assembly according to the properties or features described above or according to a combination of the features of the seal assembly which are described above. It also has the correspondingly stated advantages. The brake piston assembly comprises a brake caliper housing and a brake piston, which can be moved axially in a brake piston receptacle of the brake caliper housing and has an axial end which projects from the brake caliper housing and can apply an actuating force in an axial direction to a brake pad assembly which is present and associated therewith in the mounted state of the brake piston assembly in an electromechanical motor vehicle disc brake.

The brake piston receptacle is embodied as a bore having a first bore diameter Di1, wherein, in the region where the brake piston projects from the brake caliper housing, the bore has a bore portion having a second bore diameter Di2, Di2A, Di2B, which is larger than the first bore diameter Di1, wherein the fixing portion has a clamping portion having a first outside diameter Da1, Da1A, Da1B, wherein sizes of the second bore diameter Di2, Di2A, Di2B and the first outside diameter Da1, Da1A, Da1B are in a corresponding ratio to one another in such a way that the fixing portion is fixed axially and radially in the region of the bore portion. Alternatively or in addition, the bore portion and the clamping portion can be in a corresponding operative connection with one another in such a way that the fixing portion is fixed axially and radially in the region of the bore portion.

The bore wall of the bore portion which forms the second bore diameter Di2, Di2A, Di2B may be provided with retaining grooves which press into the lateral surface of the clamping portion, which forms the first outside diameter Da1, Da1A, Da1B. Alternatively or in addition to the retaining grooves, the abovementioned bore wall can be provided with retaining bosses, which press into the lateral surface of the clamping portion. These profiles contribute to secure positioning of the seal assembly in the brake piston assembly.

In one exemplary arrangement, the fixing portion has an abutment flange, which projects radially outwards and which rests by an abutment side oriented towards the clamping portion against the brake caliper housing, for example against an outer side of the brake caliper housing. Such an abutment flange contributes to simplified mounting since the abutment flange forms a stop during the mounting process. It furthermore contributes to secure positioning of the seal assembly in the brake piston assembly and offers additional protection from the penetration of dirt and dust.

The electromechanical motor vehicle disc brake according to the disclosure comprises a brake pad assembly and a brake piston assembly according to the properties or features described above or according to a combination of the features of the brake piston assembly which are described above. It also has the correspondingly stated advantages. Thus, the brake piston assembly also has a seal assembly according to the above-described features and properties. The brake piston assembly thus comprises a brake caliper housing and a brake piston, which can be moved axially in a brake piston receptacle of the brake caliper housing and has an axial end which projects from the brake caliper housing and can apply an actuating force in an axial direction to the brake pad assembly.

Further features, advantages and possible uses of the present disclosure will become apparent from the following description of the exemplary arrangements and the schematic FIGS. 1 to 5. For the sake of clarity, not all the elements that are illustrated in a figure are also provided with a reference sign in all cases. However, corresponding elements or regions are then designated at least in one other figure, and their significance can be gleaned there. Moreover, the same reference signs may stand for the same or similar objects in the figures.

### BRIEF DESCRIPTION OF THE DRAWINGS

FIG. 1 shows an exemplary arrangement of a brake piston assembly according to the disclosure;

FIG. 2 shows a cross-sectional view of a first exemplary arrangement of the seal assembly according to the disclosure in an installed state;

FIG. 3 shows a perspective view of the seal assembly of FIG. 2;

FIG. 4 shows a cross-sectional view of the first exemplary arrangement of the seal assembly of FIG. 2; and

FIG. 5 shows a cross-sectional view of a second exemplary arrangement of the seal assembly according to the disclosure in the installed state.

### DETAILED DESCRIPTION

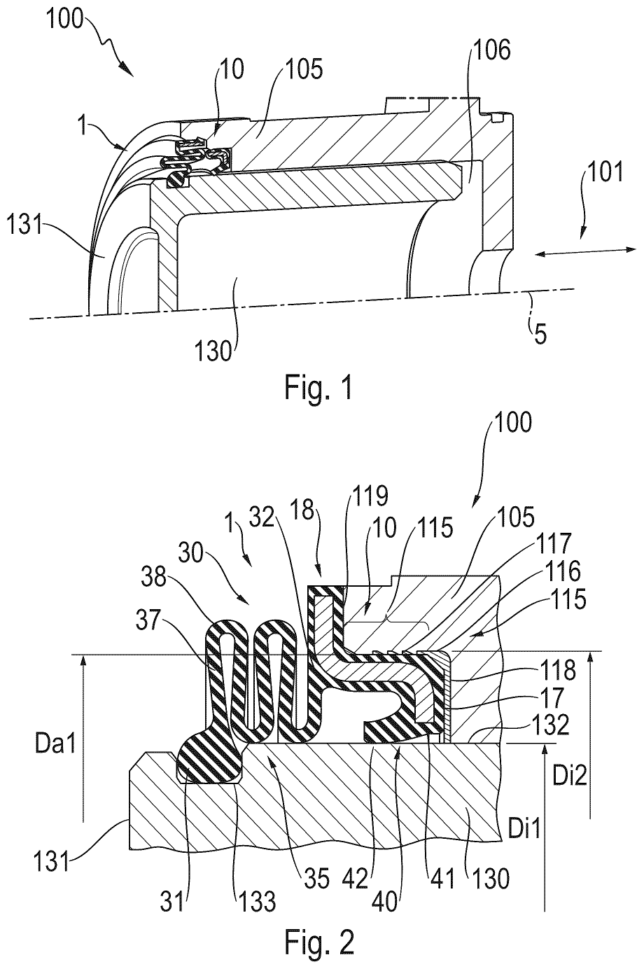

FIG. 1 illustrates a general construction of a brake piston assembly 100 according to an exemplary arrangement of the disclosure. Here, the seal assembly 1 is illustrated only on a relatively small scale, and therefore it is described in greater detail with reference to the other figures, namely, FIGS. 2 to 5. The brake piston assembly 100 comprises a brake caliper housing 105, of which only a segment of the brake caliper housing 105 is illustrated here, for example, the region of the brake piston receptacle 106. The brake piston receptacle 106 is a cylindrical bore in which the brake piston 130 is accommodated in such a way that it can move axially in the axial direction 101. That is to say that the brake piston can move in the direction of an axis of symmetry 5. On the side of the brake piston receptacle 106 which is oriented towards a brake pad assembly and a brake disc in a state of the brake piston assembly in which it is mounted in a disc brake, one axial end 131 of the brake piston 130 projects from the brake caliper housing 105 by a certain amount. This axial end 131 of the brake piston 130 is of closed design, and therefore the axial end 131 of the brake piston 130 can be driven against the brake pad assembly by actuation of the disc brake, and can produce a braking effect (the disc brake, brake pad assembly and brake disc are not illustrated). On the opposite side of the brake piston 130 from the axial end 131 in the axial direction, said piston is of open design, and it is therefore possible to install a rotation-translation mechanism or a spindle drive within the brake piston 130. This open end of the brake piston 130 is thus oriented towards the electromechanical drive.

Referring to FIG. 2, the seal assembly 1, which is of rotationally symmetrical design, is mounted in a region of an axial end 131 of the brake piston 130. Here, the seal assembly is in two-part form. A seal portion 30 is fastened in an annular groove 133 of the brake piston 130 by an encircling bead-type fastening element 31. A fixing portion 10 is pressed into a bore portion 115 of the brake piston receptacle 106. Since the figures are schematic illustrations, parts of the seal assembly 1 are not always illustrated in the form they would take in reality. Any overlaps of the material that may be present in the illustrations are therefore required purely by the drawing and would not be produced in this form in reality.

In a first exemplary arrangement of the seal assembly 1 and also of the brake piston assembly 100, which is illustrated in FIG. 2, the brake piston 130 is likewise accommodated so as to be axially movable in the brake piston receptacle 106 of the brake caliper housing 105. An encircling bead-type fastening element 31 of the rotationally symmetrical seal assembly 1 is accommodated in an annular groove 133 at the axial end 131. There is a bellows 35 adjoining the fastening element 31 successively in the axial direction 101. The folds 36 of the bellows 35 are aligned transversely to the axis of symmetry 5. The bellows 35 and the fastening element 31 are component parts of the seal portion 30. Following on in the axial direction 101, the bellows 35 is adjoined by a fixing portion 10, by a first connection portion 32, which extends outwards in the radial direction, starting from the fixing portion 10, and thus forms an abutment flange and which (the fixing portion 10) extends in the axial direction 101, by a clamping portion 15, into a bore portion 115 of the brake caliper housing 105. The bore portion 115 has an inside diameter Di2. The inside diameter Di2, which is larger than the inside diameter Di1 of the brake piston receptacle, is formed by a bore wall 116 and an annular offset surface 118. The bore wall 116 has encircling sawtooth-shaped retaining grooves 117, which ensure firm seating of the fixing portion 10 in the bore portion 115. The axial extent of the bore portion 115 is so much greater than the axial extent of the clamping portion 15 that there remains a clearance between the end face 17 of the clamping portion 15 and the offset surface 118 of the bore portion 115. The outside diameter Da1 of the clamping portion 15 rests against the inside diameter Di2 of the bore portion 115. This contributes to favourable positioning and sealing of the seal assembly. On the one hand, the abutment flange 18 forms a positioning aid during the mounting of the seal assembly 1 and an additional position securing arrangement since the said flange rests by an abutment side 19 against the outer side 119 of the brake caliper housing 105. On the other hand, the abutment flange 18 forms an additional sealing location.

In the radially inner region of the clamping portion 15, i.e. in the region which is closer to the brake piston 130, the seal portion 30 comprises a sealing lip 40, which adjoins the clamping portion 15 by a second connection portion 41. Starting from the second connection portion 41, the sealing lip 40 extends longitudinally away from the end face 17 towards a contact portion 42, which rests in an encircling and sealing manner against the piston circumferential surface 132. Starting from the second connection portion 41, the elongate sealing lip 40 furthermore slopes towards the contact portion 42 in such a way that the contact portion 42 is closer to the axis of symmetry 5 or closer to the piston circumferential surface 132 in the radial direction than the second connection portion 41. The sealing lip 40 acts like an elastic lever arm, which is mounted on the second connection portion 41 and which rests elastically against the piston circumferential surface 132, forms a seal between the contact portion 42 and the piston circumferential surface 132, and also guides the brake piston 130. The elasticity of the sealing lip 40 results from the elastically deformable elastomer from which the seal assembly 1 is manufactured. Apart from an S-shaped metal insert 12, which is cast or vulcanized into the fixing portion 10, the seal assembly 1 is manufactured integrally from an elastically deformable elastomer. The S-shaped metal insert 12 has a central part which rests in a sleeve shape in the clamping portion 15. Starting from the sleeve-shaped central part of the metal insert, a radially inward-extending limb extends to the second connection portion 41, and the radially outward-extending limb extends into the abutment flange 18. The metal insert 12 configured in this way gives the seal assembly 1 stability in a special way, such that the seal assembly 1 can be mounted in a particularly effective way and also offers secure positioning.

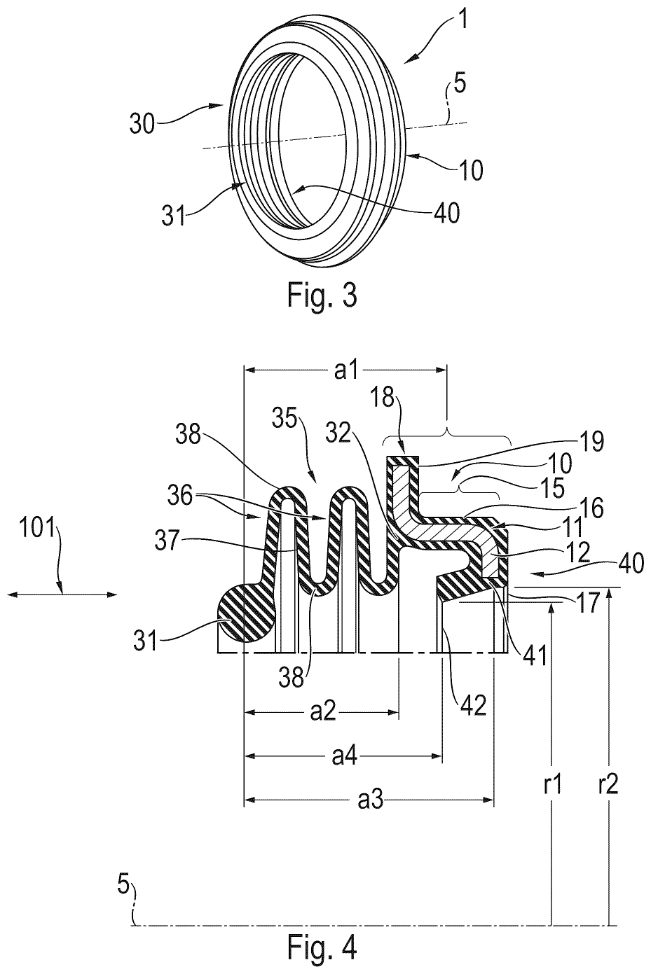

The seal assembly 1 according to a first exemplary arrangement is illustrated in full in FIG. 3, and it can be seen that the seal assembly 1 is of rotationally symmetrical and integral configuration.

The construction of the first exemplary arrangement of the seal assembly 1 is illustrated on an enlarged scale in half section in FIG. 4. The seal assembly 1 has an encircling fixing portion 10 for fixing the seal assembly 1 in the brake caliper housing 105, and the seal assembly 1 is of rotationally symmetrical configuration with respect to an axis of symmetry 5. To allow axial movement of the brake piston 130 relative to the brake caliper housing 105, the seal assembly 1 furthermore comprises a seal portion 30. This seal portion 30 can be extended or compressed axially or can be both extended and compressed axially. The seal portion 30 comprises a fastening element 31, which is spaced apart axially from the fixing portion 10 by a first distance a1 and is arranged closer to the axial end 131 of the brake piston 130 than the fixing portion 10 and which can be fastened in an encircling and sealing manner in the annular groove 133 of the brake piston 130. The seal portion 30 furthermore has a first connection portion 32, which is spaced apart axially from the fastening element 31 by a second distance a2, which is smaller than the first distance a1, and by which the seal portion 30 is connected to the fixing portion 10. The seal assembly 1 furthermore has a sealing lip 40, which is connected to the fixing portion 10 by a second connection portion 41. The second connection portion 41 is spaced apart axially from the fastening element 31 by a third distance a3, which is greater than the second distance a2, and is arranged further away from the axial end 131 of the brake piston 130 than the fastening element 31. The sealing lip 40 extends from the second connection portion 41 as far as a contact portion 41, which is spaced apart axially from the fastening element 31 by a fourth distance a4, which is smaller than the third distance a3. The sealing lip 40 has a profile which slopes relative to the axis of symmetry 5, such that the contact portion 42 is at a first radial distance r1 from the axis of symmetry 5, and the second connection portion 41 is at a second radial distance r2 from the axis of symmetry 5, which is greater than the first radial distance r1. The seal portion 30 comprises a bellows 35, which has folds 36 with elongate portions 37 and curved portions 38 connecting in each case two adjacently arranged elongate portions 37. The elongate portions 37 are aligned substantially transversely to the axis of symmetry 5. Alternatively, however, the elongate portions 37 can also be aligned substantially parallel to the axis of symmetry 5.

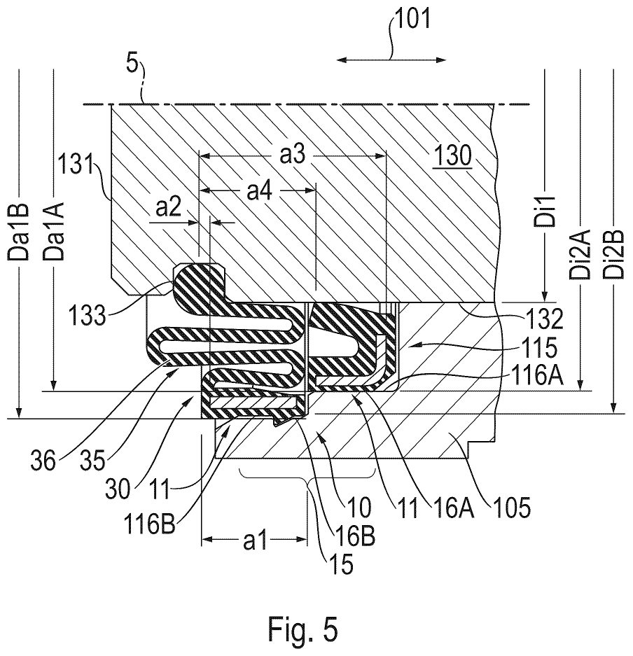

FIG. 5 shows a second exemplary arrangement of the seal assembly 1 according to the disclosure and the brake piston assembly 100. The essential difference with respect to the first exemplary arrangement described above is that, disregarding the metal reinforcement 11, the seal assembly 1 is of two-part design and that the bore portion 115 is of two-stage configuration, i.e. has two diameters Di1A and Di1B. The bore stage with the diameter Di1A is machined deeper into the brake caliper 105 than the bore stage with the diameter Di1B. Di1B is larger than Di1A, and both Di1A and Di1B are larger than the diameter Di1 of the brake piston receptacle 106. The fixing portion 10, including the clamping portion 15, the second connection portion 41 and the sealing lip 40, are pressed into the bore stage with the diameter Da1A. The clamping portion 15 rests by an outside diameter Da1A against Di1A. Apart from an abutment flange, which the fixing portion 10 of the second exemplary arrangement does not include, the construction of the fixing portion 10 is equivalent to that of the first exemplary arrangement.

The seal portion 30 of the second exemplary arrangement is connected via a first connection portion 32 to another part of the fixing portion, which is accommodated by an outside diameter Da1B in the bore stage with the diameter Di1B. Here, the elongate portions 37 of the bellows 35 are aligned substantially parallel to the axis of symmetry 5 but could also be configured in such a way as to be aligned transversely to the axis of symmetry 5. Here too, the seal portion 30 is fastened by a fastening 31 in an annular groove 133 machined in at the axial end 131 of the brake piston 130.

1. A seal assembly for a brake piston assembly for an electromechanical motor vehicle disc brake, wherein the brake piston assembly comprises a brake caliper housing and a brake piston, which can be moved axially in a brake piston receptacle of the brake caliper housing and has an axial end which projects from the brake caliper housing and can apply an actuating force in an axial direction to a brake pad assembly which is present and associated therewith in a mounted state of the brake piston assembly in an electromechanical motor vehicle disc brake,
wherein the seal assembly is of rotationally symmetrical configuration with respect to an axis of symmetry and comprises an encircling fixing portion for fixing the seal assembly in the brake caliper housing,
wherein, to allow axial movement of the brake piston relative to the brake caliper housing, the seal assembly comprises a seal portion which can be extended and/or compressed axially, the seal portion further comprising
a fastening element, which is spaced apart axially from the fixing portion by a first distance and is arranged closer to the axial end of the brake piston than the fixing portion and which can be fastened in an encircling and sealing manner on the brake piston, and
a first connection portion, which is spaced apart axially from the fastening element by a second distance, which is smaller than the first distance, or which is not spaced apart axially from the fastening element, and by which the seal portion is connected in an encircling manner to the fixing portion, and
wherein the seal assembly has an encircling sealing lip, which is connected in an encircling manner to the fixing portion by a second connection portion, which is spaced apart axially from the fastening element by a third distance, which is greater than the second distance, and is arranged further away from the axial end of the brake piston than the fastening element,
wherein the sealing lip extends from the second connection portion as far as a contact portion, which is spaced apart axially from the fastening element by a fourth distance, which is smaller than the third distance, wherein, at least in an unmounted state of the seal assembly, the sealing lip has a profile which slopes relative to the axis of symmetry, such that the contact portion is at a first radial distance from the axis of symmetry, and the second connection portion is at a second radial distance from the axis of symmetry, which is greater than the first radial distance.

2. The seal assembly according to claim 1, wherein, in a mounted state of the seal assembly in the brake piston assembly, the contact portion rests against a piston circumferential surface of the brake piston and exerts a first contact force against it, and the second connection portion does not rest against the piston circumferential surface or exerts a lower contact force on the piston circumferential surface than the first contact force.

3. The seal assembly according to claim 2, wherein the sealing lip is manufactured from an elastically deformable elastomer, and the first contact force is brought about exclusively on the basis of the deformation of the sealing lip produced in an installed state of the seal assembly in the brake piston assembly.

4. The seal assembly according to claim 1, wherein the seal assembly is composed predominantly of an elastically deformable elastomer.

5. The seal assembly according to claim 1, wherein the fixing portion has an encircling metal reinforcement, in particular an internal metal reinforcement.

6. The seal assembly according to claim 5, wherein the encircling metal reinforcement comprises an encircling metal insert which is angular or S-shaped when considered in profile.

7. The seal assembly according to claim 1, wherein the seal portion comprises a bellows, which has folds with elongate portions and curved portions connecting in each case two adjacently arranged elongate portions, wherein the elongate portions are aligned substantially parallel to the axis of symmetry.

8. The seal assembly according to claim 1, one of the preceding claims, wherein the fixing portion, the seal portion and the sealing lip are connected integrally to one another.

9. A brake piston assembly for an electromechanical motor vehicle disc brake having a seal assembly according to claim 1, wherein the brake piston assembly comprises a brake caliper housing and a brake piston, which can be moved axially in a brake piston receptacle of the brake caliper housing and has an axial end which projects from the brake caliper housing and can apply an actuating force in an axial direction to a brake pad assembly which is present and associated therewith in a mounted state of the brake piston assembly in an electromechanical motor vehicle disc brake.

10. The brake piston assembly according to claim 9, wherein the brake piston receptacle is embodied as a bore having a first bore diameter, wherein, in a region where the brake piston projects from the brake caliper housing, the bore has a bore portion having a second bore diameter, which is larger than the first bore diameter, wherein the fixing portion has a clamping portion having a first outside diameter, wherein sizes of the second bore diameter and the first outside diameter are in a corresponding ratio to one another in such a way.

11. The brake piston assembly according to claim 10, wherein the bore wall of the bore portion which forms the second bore diameter is provided with retaining grooves and/or retaining bosses which press into the lateral surface of the clamping portion, which forms the first outside diameter.

12. The brake piston assembly according to claim 10, wherein the fixing portion has an abutment flange, which projects radially outwards and which rests by an abutment side oriented towards the clamping portion against the brake caliper housing.

13. An electromechanical motor vehicle disc brake having a brake pad assembly, having a seal assembly according to claim 1 and having a brake piston assembly, wherein the brake piston assembly comprises a brake caliper housing and a brake piston, which can be moved axially in a brake piston receptacle of the brake caliper housing and has an axial end which projects from the brake caliper housing and can apply an actuating force in an axial direction to the brake pad assembly.

14. The sealing assembly of claim 1, wherein the fixing portion is fastened in an encircling and sealing manner in an annular groove encompassed by the brake piston.

15. The sealing assembly of claim 5, wherein the encircling metal reinforcement is an internal metal reinforcement.

16. The seal assembly according to claim 1, wherein the seal portion comprises a bellows, which has folds with elongate portions and curved portions connecting in each case two adjacently arranged elongate portions, wherein the longitudinal portions are aligned substantially transversely to the axis of symmetry.

17. The seal assembly according to claim 1, wherein the contact portion, the second connecting portion and the fixing portion are connected integrally to one another.

18. The seal assembly according to claim 1, wherein the contact portion, the second connecting portion and the fixing portion are connected integrally to one another.

19. The brake piston assembly according to claim 9, wherein the brake piston receptacle is embodied as a bore having a first bore diameter, wherein, in a
